(19) United States
(12) Patent Application Publication
(10) Pub. No.: US 2016/0224303 A1
(43) Pub. Date: Aug. 4, 2016

(54) METHOD AND SYSTEM FOR RENDERING DESIGNATED CONTENT ITEMS

(71) Applicant: Kobo Incorporated, Toronto (CA)

(72) Inventor: Juan Ernesto Salas IMANA, Toronto (CA)

(73) Assignee: KOBO INCORPORATED, Toronto (CA)

(21) Appl. No.: 14/613,119

(22) Filed: Feb. 3, 2015

(51) Int. Cl. G06F 3/14

(52) U.S. Cl. CPC G06F 3/1423

(57) ABSTRACT

A method and system for deploying a display screen of an electronic personal display device in rendering digital content items. The device includes a processor, primary and secondary touch screen displays, and a memory storing instructions. The method comprises receiving a request for accessing an e-book stored in a designated container of an e-library, the container designating the e-book for reading via the secondary touch screen display, the e-book having content displayable in a series of digitally constructed pages, activating the secondary display screen for operation, and transitioning operation of the computing device to the secondary display screen by rendering the e-book content for reading thereon

### TECHNICAL FIELD

Examples described herein relate to a system and method for operating a computing device for rendering contents items thereon.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from, or coupled to, but distinct from the electronic personal display itself. Some examples of electronic personal displays include mobile digital devices/tablet computers and electronic readers (e-readers) such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, Kobo Aura H2O, Kobo GLO and the like).

Some electronic personal display devices are purpose built devices designed to perform especially well at displaying digitally stored content for reading or viewing thereon. For example, a purpose build device may include a display that reduces glare, performs well in high lighting conditions, and/or mimics the look of text as presented via actual discrete pages of paper. While such purpose built devices may excel at displaying content for a user to read, they may also perform other functions, such as displaying images, emitting audio, recording audio, and web surfing, among others.

Electronic personal display devices are among numerous kinds of consumer devices that can receive services and utilize resources across a network service. Such devices can operate applications or provide other functionality that links a device to a particular account of a specific service. For example, the electronic reader (e-reader) devices typically link to an online bookstore, and media playback devices often include applications that enable the user to access an online media electronic library (or e-library). In this context, the user accounts can enable the user to receive the full benefit and functionality of the device.

Yet further, such devices may incorporate a touch screen display having integrated touch sensors and touch sensing functionality, whereby user input commands via touch-based gestures are received thereon.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIGS. 1A, 1B illustrate a computing device configured for operation in transitioning between dual display screens for designated content renderable thereon, in an embodiment.

FIG. 2 illustrates a schematic architecture of a computing device configured with dual display screens, for operation in transitioning between the screens based on content designation, according to an embodiment.

FIG. 3 illustrates an example embodiment in an alternate view of a computing device for operation related to transitioning between display screens.

FIG. 4 illustrates a method for operating a computing device to transition between dual screens for rendering of specially designated content, according to an embodiment.

### DETAILED DESCRIPTION

“E-books” are a form of electronic publication content stored in digital format in a computer non-transitory memory, viewable on a computing device having display functionality. An e-book can correspond to, or mimic, the paginated format of a printed publication for viewing, such as provided by printed literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., specialized e-reading application software) to view e-books in a format that mimics the paginated printed publication. Still further, some devices (sometimes labeled as “e-readers”) can display digitally-stored content in a more reading-centric manner, while also providing, via a user input interface, the ability to manipulate that content for viewing, such as via discrete pages arranged sequentially (that is, pagination) corresponding to an intended or natural reading progression, or flow, of the content therein.

An “e-reading device”, variously referred to herein as an electronic personal display or mobile computing device, can refer to any computing device that can display or otherwise render an e-book. By way of example, an e-reading device can include a mobile computing device on which an e-reading application can be executed to render content that includes e-books (e.g., comic books, magazines, etc.). Such mobile computing devices can include, for example, a multi-functional computing device for cellular telephony/messaging (e.g., feature phone or smart phone), a tablet computer device, an ultra-mobile computing device, or a wearable computing device with a form factor of a wearable accessory device (e.g., smart watch or bracelet, glass-wear integrated with a computing device, etc.). As another example, an e-reading device can include an e-reader device, such as a purpose-built device that is optimized for an e-reading experience (e.g., with e-Ink displays).

While engaged in an immersive e-reading experience, a combination of factors such as ambient lighting brightness, reflection and glare from the display screen while viewing displayed content may significantly affect reading comfort and enjoyment of the user's reading experience. A user should ideally be able to read comfortably for extended periods of time on the device display screen, to provide a digital reading experience that is comparable to the natural convenience of reading a physical paper book. It would be further preferable that a display screen consume relatively minimal device battery power, to enable reading for lengthy, immersive periods without having to recharge the device battery.

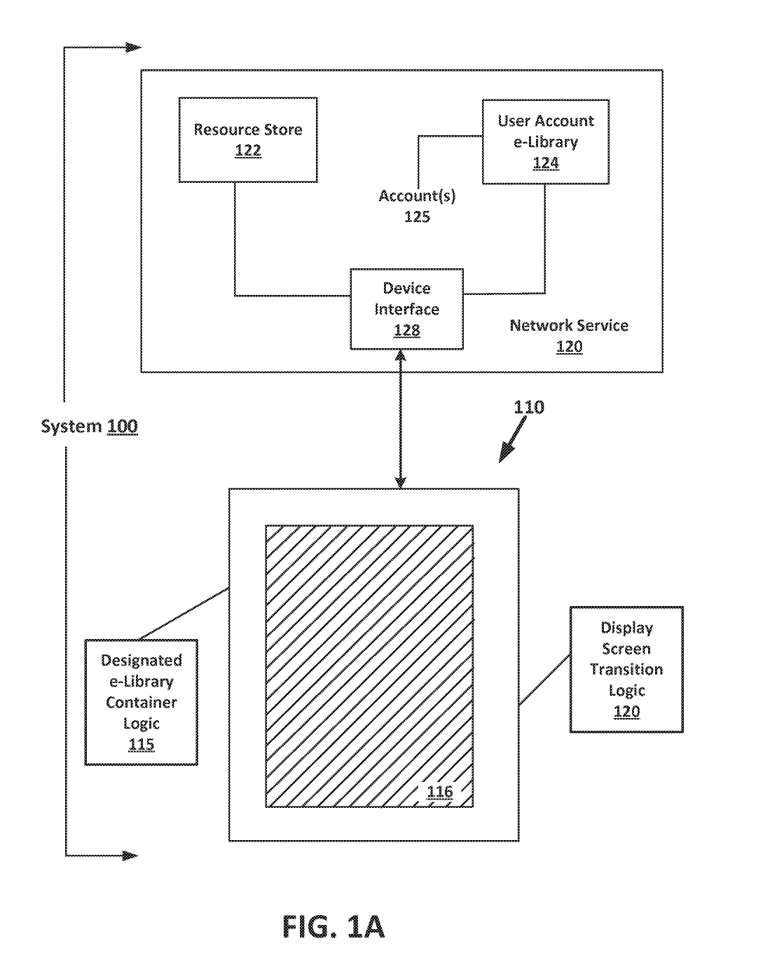

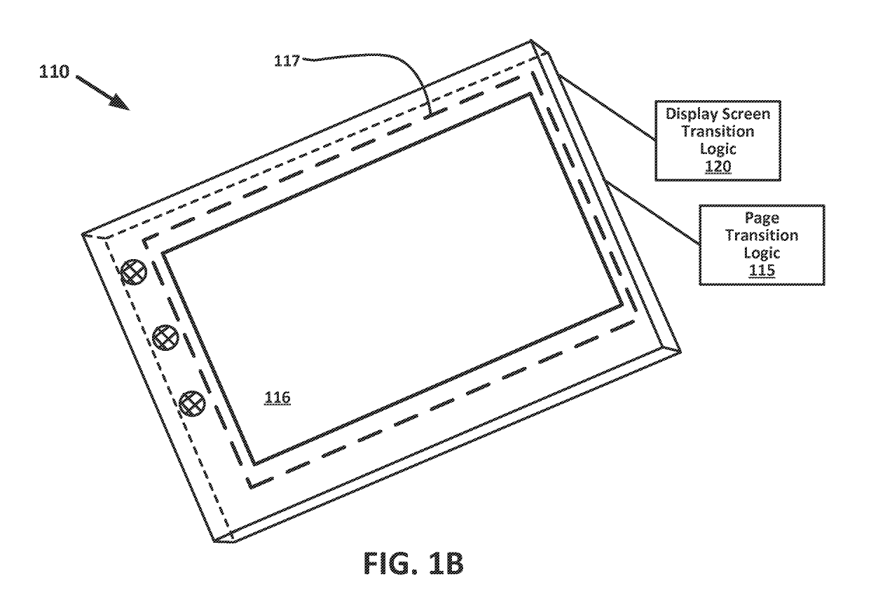

FIG. 1A illustrates a system 100 for utilizing applications and providing e-book services on a computing device, according to an embodiment. In an example of FIG. 1A, system 100 includes an electronic personal display device, shown by way of example as an e-reading device 110, and a network service 120. The network service 120 can include multiple servers and other computing resources that provide various services in connection with one or more applications that are installed on the e-reading device 110. By way of example, in one implementation, the network service 120 can provide e-book services in communication with e-reading device 110. The e-book services provided through network service 120 can, for example, include services in which e-books are sold, shared, downloaded or stored. More generally, the network service 120 can provide various other content services, including content rendering services (e.g., streaming media) or other network-application environments or services.

The e-reading device 110 can correspond to any electronic personal display device on which applications and digital content items (e.g., e-books, media files, documents) can be rendered for consumption. For example, the e-reading device 110 can correspond to a tablet or a telephony/messaging device (e.g., smart phone). In one implementation, for example, e-reading device 110 can run an e-reader application that links the device to the network service 120 and enables e-books provided through the service to be viewed and consumed. In another implementation, the e-reading device 110 can run a media playback or streaming application that receives tiles or streaming data from the network service 120. By way of example, the e-reading device 110 can be equipped with hardware and software to optimize certain application activities, such as reading electronic content (e.g., e-books). For example, the e-reading device 110 can have a tablet-like form factor, although variations are possible. In some cases, the e-reading device 110 can also have an e-ink display.

In additional detail, the network service 120 can include a device interface 128, a resource store 122 and a user e-library 124. User e-library 124 can associate e-reading device 110 with a user and with account 125. Account 125 can also be associated with one or more application resources (e.g., e-books), which can be stored in user electronic library (e-library) 124 containing digital content items. The user account 125 in this manner is associated with ownership of, and accessibility to, one or more e-books and digital content items stored in e-library 124. The device interface 128 can handle requests from the e-reading device 110, and further interface the requests of the device with services and functionality of the network service 120. The device interface 128 can utilize information provided with user account 125 in order to enable services, such as purchasing downloads of content or determining what e-books and content items are associated with the user device. Additionally, the device interface 128 can provide the e-reading device 110 with access to the content store 122, which can include, for example, an online store. The device interface 128 can handle input to identify content items (e.g., e-books), and further to link content items to the account 125 of the user.

Yet further, user e-library 124 can retain metadata for individual accounts 125 to identify resources or content that have been purchased or made available for consumption for a given account. The e-reading device 110 may be associated with the user account 125, and multiple devices may be associated with the same account. As described in greater detail below, the e-reading device 110 can store digital content items (e.g., e-books) that are purchased or otherwise made available to the user of the e-reading device 110, as well as to archive e-books and other digital content items that have been purchased for the user account 125 and are not stored on a particular computing device, but rather at a user's e-library 124 which may be hosted at a remote, cloud-based server system.

FIG. 1B illustrates a computing mobile device 110, in one embodiment configured for operation of a primary display screen 116 and a secondary display screen 117. In the example of FIG. 1B, computing device 110 comprises an electronic personal display device, shown by way of example as e-reading device 110. The terms e-reading device, computing device and electronic personal display device are used interchangeably herein. In some cases, display screen 116 of e-reading device 110 may be a liquid crystal display and display screen 117 may be e-ink display or bi-stable display.

Further with reference to an example depiction of FIG. 1B, the display screens 116, 117 may be touch-sensitive, to process touch inputs including gestures, e.g., a swipe gesture comprising a sustained touch while moving along a particular direction upon the touchscreen surface). For example, the display screens 116, 117 may be integrated with one or more touch sensors to provide a touch-sensing region on their respective display surfaces. For some embodiments, the one or more touch sensors may include capacitive sensors that can sense or detect a human body's capacitance as input. In the example of FIG. 1B, the touch-sensing region coincides with a substantial surface area, if not all, of the display screens 116, 117 respectively.

In some embodiments, the e-reading device 110 includes features for providing functionality related to displaying paginated content. The e-reading device 110 can include page transition logic which enables the user to transition through paginated content. The e-reading device 110 can display pages from e-books, and enable the user to transition from one page state to another, including advancing forward or backward within the pages of e-book content. In particular, an e-book can provide content that is rendered according to a sequence of digitally constructed pages, and the e-book can display page states in the form of single pages, multiple pages or portions thereof. In alternate embodiments, the e-book may be an e-magazine or an e-comic book, wherein each of the digitally constructed pages includes several distinctive panels or frames of text and/or images, and reading progression within a page may include navigating in sequential steps from one such panel or frame to another within a same page. Accordingly, a given page state can coincide with, for example, a single page, or two or more pages displayed at once. The page transitioning logic can operate to enable the user to transition from a given page state to another page state. In some implementations, the page transitioning logic enables single page transitions, chapter transitions, or cluster transitions (multiple pages at one time) within the sequence of digitally constructed pages comprising the e-book.

The page transitioning logic can be responsive to various kinds of interfaces and actions in order to enable page transitioning. In one implementation, the user can signal a page transition event to transition page states by, for example, interacting with the touch-sensing region of the display screens 116, 117 of electronic personal display device 110. For example, the user may swipe the surface of the display screens 116, 117 in a particular direction (e.g., up, down, left, or right) to indicate a sequential direction of a page transition. In variations, the user can specify different kinds of page transitioning input (e.g., single page turns, multiple page turns, chapter turns, etc.) through different kinds of input. Additionally, the page turn input of the user can be provided with a magnitude to indicate a magnitude (e.g., number of pages) in the transition of the page state. For example, a user can touch and hold the surface of the display screen 116 in order to cause a cluster or chapter page state transition, while a tap (as distinguished from a directional swipe, in an embodiment) in the same region can effect a single page state transition (e.g., from one page to the next in sequence). In another example, a user can specify page turns of different kinds or magnitudes through single taps, sequenced taps or patterned taps on the touch sensing region of the display screens 116, 117.

According to some embodiments, the e-reading device 110 includes display sensor logic to detect and interpret user input or user input commands made through interaction with the touch sensors of display screens 116, 117. By way of example, display sensor logic can detect a user making contact with the touch-sensing region of the display screens 116, 117, otherwise referred to herein as a touch event. More specifically, display sensor logic can detect a touch event also referred to herein as a tap, an initial tap held in contact at display screens 116, 117 for longer than some pre-defined threshold duration of time (otherwise known as a “long press” or a “long touch”), multiple taps performed either sequentially or generally simultaneously, swiping gesture actions made through user interaction with the touch sensing region of the display screens 116, 117 or any combination of these gesture actions. Although referred to herein as a “touch” or a tap, it should be appreciated that in some design implementations, sufficient proximity to the screen surface, just short of actual physical contact, may register a “contact” or a “touch event”. Furthermore, display sensor logic can interpret such interactions in a variety of ways. For example, each such interaction may be interpreted as a particular type of user input associated with a respective input command, execution of which may trigger a change in state at touchscreen displays 116, 117.

Display screen transition logic module 120 provides, in an embodiment, for activation and transitioning of operation between touchscreen displays 116, 117 of personal display device 110. Display screen transition logic module 120 includes logic providing, in part, to accomplish activation of, and transitioning operation between, activation and operation of touchscreen displays 116, 117 based on input a touchscreen input at one of displays 116, 117 that is interpreted by a processor of display device 110 as a page transition input command enacted via a gesture action performed upon e-book page content being displayed thereon.

Display screen transition logic module 120 and designated e-library container logic module 115 can be implemented as software modules comprising instructions stored in a memory of a computing device such as the content store server and/or display device 110. One or more embodiments of display screen transition logic module 120 and/or designated e-library container logic module 115 described herein may be implemented using programmatic modules or components. A programmatic module or component may include a program, a subroutine, a portion of a program, or a software or a hardware component capable of performing one or more stated tasks or functions in conjunction with one or more processors. As used herein, a module or component can exist on a hardware component independently of other modules or components. Alternatively, a module or component can be a shared element or process of other modules, programs and hardware components.

Furthermore, the one or more embodiments of display screen transition logic module 120 and designated e-library container logic module 115 described herein may be implemented through instructions that are executable by one or more processors. These instructions may be stored on a computer-readable non-transitory medium. In particular, the numerous computing and communication devices shown with embodiments of the invention include processor(s) and various forms of computer memory, including volatile and non-volatile forms, storing data and instructions. Examples of computer-readable mediums include permanent memory storage devices, such as hard drives on personal computers or servers. Other examples of computer storage mediums include portable storage units, flash or solid-state memory (such as included on many cell phones and consumer electronic devices) and magnetic memory. Computers, terminals, network enabled devices (e.g., mobile devices such as cell phones and wearable computers) are all examples of machines and devices that utilize processors, memory, and instructions stored on computer-readable mediums. Additionally, embodiments may be implemented in the form of computer-programs, or a computer usable storage medium capable of storing such a program.

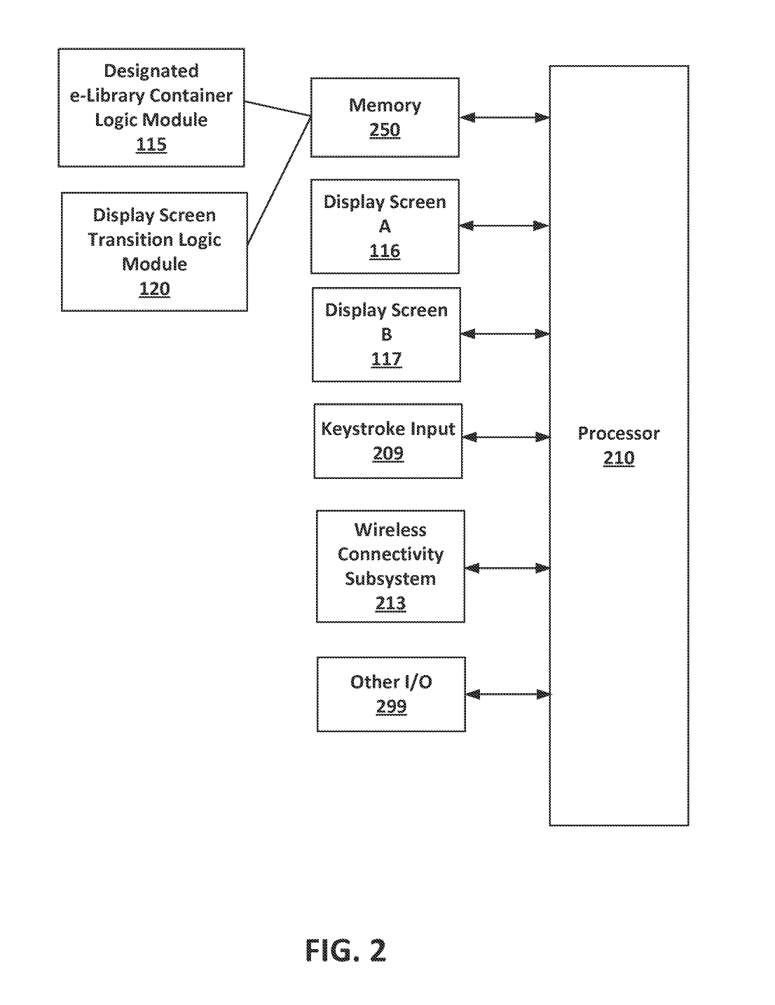

With reference now to FIG. 2, illustrated is a schematic architecture of a mobile computing device, such as a tablet or e-reader, configured for transition operation between dual display screens 116, 117, according to an embodiment.

E-reading device 110 further includes processor 210, a memory 250 storing instructions and logic pertaining at least to display sensor logic, display screen transition logic module 120 and designated e-library container logic module 115.

Processor 210 can implement functionality using the logic and instructions stored in memory 250. Additionally, in some implementations, processor 210 communicates with the network service. More specifically, the e-reading device 110 can access the network service to receive various kinds of resources (e.g., digital content items such as e-books, configuration files, account information), as well as to provide information (e.g., user account information, service requests etc.). For example, e-reading device 110 can receive application resources, such as e-books or media files, that the user elects to purchase or otherwise download via a network service. The application resources, including e-books having content organized as a series of digitally constructed pages, that are downloaded onto the e-reading device 110 can be stored in memory 250.

In some implementations, primary display screen 116 can correspond to, for example, a liquid crystal display (LCD) or light emitting diode (LED) display that illuminates in order to provide content generated from processor 210. In some implementations, display 116 can be touch-sensitive. For example, in some embodiments, one or more of the touch sensor components may be integrated with display 116. In other embodiments, the touch sensor components may be provided (e.g., as a layer) above or below display 116 such that individual touch sensor components track different regions of display 116.

Secondary display 117 can correspond to an electronic paper type display, such as an e-ink or bi-stable display that mimic conventional paper in the manner in which content is displayed. Typically, e-ink displays are more suited to e-reading under extreme ambient lighting conditions, such as very bright daylight or in near-darkness at bedtime, for long, immersive periods, resulting is less eye strain as compared to reading, for example, on an LCD display screen. Examples of such electronic paper display technologies include electrophoretic displays, electro-wetting displays, and electro-fluidic displays. Secondary display 117 can also be touch-sensitive; for example, in some embodiments, one or more of the touch sensor components may be integrated with display 117, providing touch screen capability. Yet further, e-ink displays embodied in secondary display 117 consume relatively very minimal device battery power in comparison with, for example, an LCD display used in primary display screen 116. In some cases, e-ink displays consume computing device battery power at a less than 10 percent rate as compared to consumption of an LCD primary screen. For yet this additional reason, an e-ink screen as embodied in secondary display screen 117 would be very desirable for lengthy, immersive periods of reading e-book content via e-reading device 110.

Processor 210 can receive input from various sources, including touch sensor components at displays 116, 117, keystroke input 209 such as from a virtual or rendered keyboard, and other input mechanisms 299 (e.g., buttons, mouse, microphone, etc.). With reference to examples described herein, processor 210 can respond to input detected at the touch sensor components. In some embodiments, processor 210 responds to inputs from the touch sensor components in order to facilitate or enhance e-book activities such as generating e-book content on displays 116, 117, performing page transitions of the displayed e-book content, powering off the device 110 and/or displays 116, 117, activating a screen saver, launching or closing an application, and/or otherwise altering a state of displays 116, 117.

In some embodiments, memory 250 may store display sensor logic that monitors for user interactions detected through the touch sensor components, and further processes the user interactions as a particular input or type of input. In an alternative embodiment, display sensor logic module may be integrated with the touch sensor components. For example, the touch sensor components can be provided as a modular component that includes integrated circuits or other hardware logic, and such resources can provide some or all of display sensor logic. In variations, some or all of display sensor logic may be implemented with processor 210 (which utilizes instructions stored in memory 250), or with an alternative processing resource.

E-reading device 110 further includes wireless connectivity subsystem 213, comprising a wireless communication receiver, a transmitter, and associated components, such as one or more embedded or internal antenna elements, local oscillators, and a processing module such as a digital signal processor (DSP) (not shown). As will be apparent to those skilled in the field of communications, the particular design of wireless connectivity subsystem 213 depends on the communication network in which display device 110 is intended to operate, such as in accordance with Wi-Fi, Bluetooth, Near Field Communication (NFC) communication protocols, and the like.

Display screen transition logic module 120 can be implemented as a software module, comprising instructions stored in memory 250, on mobile display device 110. In one implementation, the local memory 250 can include records for each e-book in the user's e-library account. The user may have the content portion of select e-books archived remotely at a computer server cloud system, so as not to reside in the local memory 250, but be provided by the network service upon request or as needed.

Designated e-library container logic module 119 uses e-library container accessing detection logic to keep track of content items designated for e-reading via secondary touch screen display 117 of computing device 110. Such designated content items collectively form a designated container, which may manifest as a distinct and separate section of an e-library in a device memory, and comprise a distinct and separate section of that device memory accordingly. In other variations, it is contemplated that no distinct and separate section of memory is used, but rather the designated container comprises only an organizational format, whereby e-books may be disparately located across an interface display view of e-library 124 contents. Upon a request for access, such as when a user clicks or double clicks to open a particular e-book or other content item, designated e-library container logic module 119 operates in conjunction with display screen transition logic module to activate secondary display screen 117, for transitioning content of the e-book for viewing thereon, in accordance with the designation of such content for e-reading via secondary touchscreen display 1117.

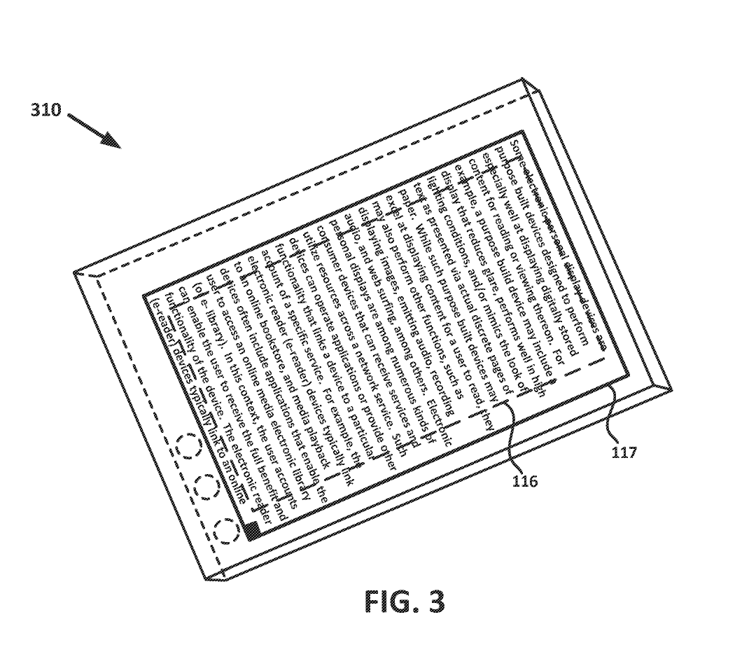

Next, in reference to FIG. 3, depicted is an example embodiment in view 310 of an activated secondary display screen 117 of computing device 110, rendering specially designated e-book content, the content designated for rendering thereon in accordance with an e-library container designation.

In this case depicted, display screen 117 is disposed on a rear housing face of computing device 110, oppositely located the front housing face that includes primary display screen 116. Upon a request for access, such as when a user clicks or double clicks to open a particular e-book or other content item, designated e-library container logic module 119 operates in conjunction with display screen transition logic module to activate secondary display screen 117. Secondary display screen 117 may be activated via processor 210, whereupon display of the e-book content is transitioned for displaying and reading upon secondary display screen 117 of computing device 110.

Optionally, upon transitioning operation of e-reading device 110 for e-reading of e-book content on secondary display 117, primary display screen 116 may be de-activated into a lower power mode, such as a sleep mode or power-off mode, for power conservation benefits, at least while rendering the e-book content via secondary display screen 117.

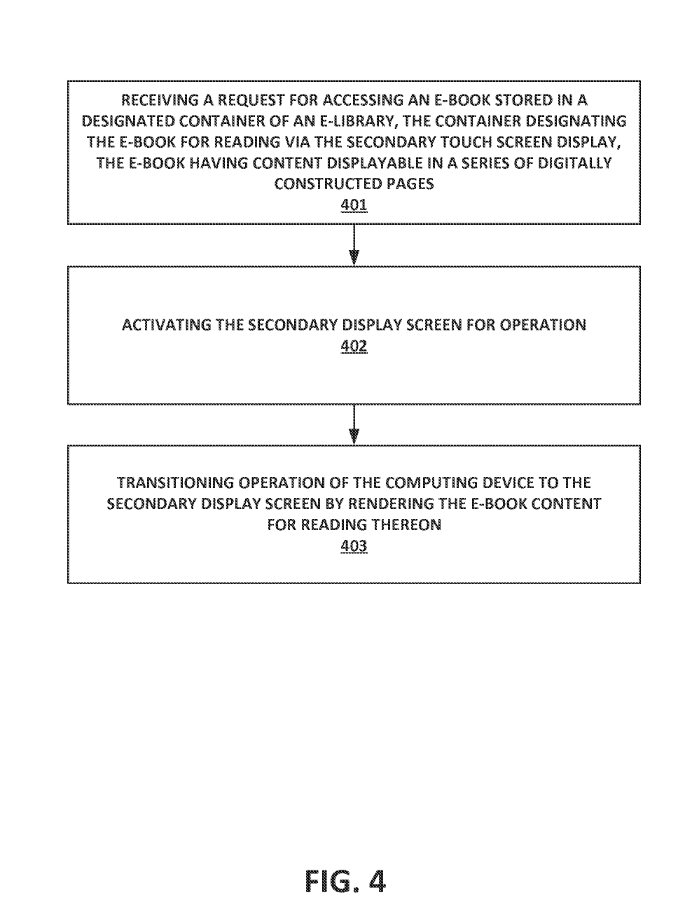

Next with reference to FIG. 4, illustrated is a method for operation in deploying an alternate one of dual screens 116, 117 of computing device 110 on detecting a request for accessing a designated container of an e-library or other repository of a collection of digital content items and/or e-books, according to an embodiment. The request for access may be embodied in a user's act of selecting an e-book and opening it for e-reading (such as via a double-click action). The e-book The entire library be so designated as the container, so any e-book therein will be considered as falling under the applicable rules for content of the designated contained. In another embodiment, the e-books may bear the container designation, but may comprise e-books disparately situated within e-library 124 interface view showing contents therein. In another variation, the container may be a designated e-reading queue of e-books, such as a “next-read” collection of e-book titles which the user has acquired and stored in e-library 124 collection, but has not yet started, or completed, reading. The e-books and e-library may be stored local in device memory or remotely via a hosted e-library server system. In describing the example of FIG. 4, reference will be made to components such as described with regard to FIGS. 1A, 1B through 3 for purposes of illustrating components for performing a step or sub-step as described.

At step 401, receiving a request for accessing an e-book stored in a designated container of an e-library 124, the container designating the e-book for reading via the secondary touch screen display 117 of computing device 110. In some embodiments, secondary touch screen display 117 may be part of a separate but attachable device accessory, such as a device 110 cover, whereupon attachment, secondary touch screen display 117 is electrically coupled to device 110 for purposed of being controlled by processor 210.

At step 402, activating the secondary display screen 117 for operation.

At step 403, transitioning operation of the computing device 110 to the secondary display screen 117 by rendering the e-book content for reading thereon.

Although illustrative embodiments have been described in detail herein with reference to the accompanying drawings, variations to specific embodiments and details are contemplated and encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method executed in a processor of a computing device, the computing device further including a primary and a secondary touch screen displays and a memory storing instructions, the method comprising:
receiving a request for accessing an e-book stored in a designated container of an e-library, the container designating the e-book for reading via the secondary touch screen display, the e-book having content displayable in a series of digitally constructed pages;
activating the secondary display screen for operation; and
transitioning operation of the computing device to the secondary display screen by rendering the e-book content for reading thereon.

2. The method of claim 1 wherein the primary display screen comprises a liquid crystal display (LCD) screen.

3. The method of claim 1 wherein the primary display screen comprises a light emitting diode (LED) screen.

4. The method of claim 1 wherein the secondary display screen is a bi-stable e-ink display screen.

5. The method of claim 1 further comprising de-activating the primary display screen for operation while rendering the e-book content for reading on the secondary display screen.

6. The method of claim 1 wherein the e-book content is one of an e-magazine and an e-comic.

7. The method of claim 1 wherein the designated container comprises the e-library.

8. The method of claim 1 wherein the designated container comprises a next-read queue of e-books within the e-library.

9. The method of claim 1 wherein the designated container comprises a collection of designated ones of digital content items within the e-library.

10. The method of claim 1 wherein the e-library is accessibly hosted at a cloud-based server system.

11. A computer-readable medium that stores instructions and an e-book for a computing device, the computing device including a processor, a primary and a secondary touch screen displays, and a memory storing instructions, the instructions being executable by the processor to cause the computing device to perform operations that include:
receiving a request for accessing an e-book stored in a designated container of an e-library, the container designating the e-book for reading via the secondary touch screen display, the e-book having content displayable in a series of digitally constructed pages;
activating the secondary display screen for operation; and
transitioning operation of the computing device to the secondary display screen by rendering the e-book content for reading thereon.

12. A computing device comprising:
a memory that stores a set of instructions and an e-book having digital content arranged in a series of digitally constructed pages;
a primary and a secondary touch screen displays; and
a processor that access the instructions in memory, the processor further configured to:
receive a request for accessing an e-book stored in a designated container of an e-library, the container designating the e-book for reading via the secondary touch screen display, the e-book having content displayable in a series of digitally constructed pages;
activate the secondary display screen for operation; and
transition operation of the computing device to the secondary display screen by rendering the e-book content for reading thereon.

13. The computing device of claim 12 wherein the primary display screen comprises a liquid crystal display (LCD) screen.

14. The computing device of claim 12 wherein the secondary display screen is an e-ink display screen.

15. The computing device of claim 12 Therein the second. y display screen is a bi-stable display screen.

16. The computing device of claim 12 further comprising de-activating the primary display screen for operation in rendering the pages of e-book content.

17. The computing device of claim 12 wherein the designated container comprises the e-library.

18. The computing device of claim 12 wherein the designated container comprises a next-read queue of e-books within the e-library.

19. The computing device of claim 12 wherein the designated container comprises a collection of designated ones of digital content items within the e-library.

20. The computing device of claim 12 wherein the e-library is accessibly hosted at a cloud-based server system.
